(19) United States
(12) Patent Application Publication
(10) Pub. No.: US 2002/0138757 A1
(43) Pub. Date: Sep. 26, 2002

(54) Method for securely distributing software components on a computer network

(75) Inventors: James T. Lynn, Issaquah, WA (US); Todd C. Shaneyfelt, Phoenix, AZ (US); Michael T. Smith, Mesa, AZ (US); James E. Greenwood JR., Scottsdale, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/814,601

(22) Filed: Mar. 23, 2001

(51) Int. Cl. H04L 9/00

(52) U.S. Cl. 713/201

(57) ABSTRACT

A method for securely transmitting information from a network appliance is disclosed. The method includes initially executing a secure kernel and a configuration file containing a load file onto the network appliance. The secure kernel is used to verify the authenticity of the configuration file and a load table within the configuration file.

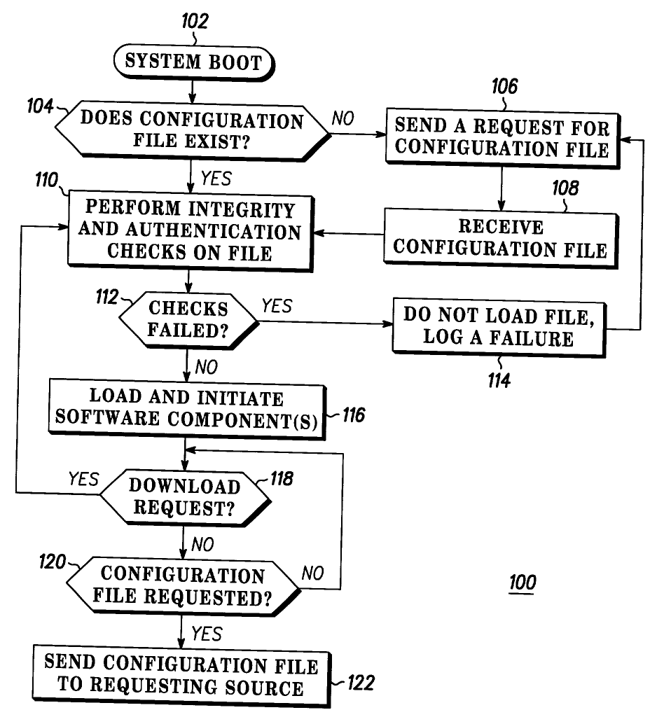

### TECHNICAL FIELD

The present invention relates, generally, to the secure distribution of software components in a network environment and, more particularly, to a method for securely authenticating each network user's configuration file to assure the authenticity and integrity of downloaded components.

### BACKGROUND ART AND TECHNICAL PROBLEMS

In a typical computer network, a host or server computer maintains a number of files, programs, and applications which can be accessed by the various clients or network users. In this context, the term “network users” may include personal computers, television set-top boxes, or the like.

One of the functions of the operating system (OS) which resides on the network appliance (e.g., personal computer, set-top box, satellite dish) is to download software updates in the form of components or plug-in modules over the network. In some cases, the operating system is also required to download a new version of the operating system to the network appliance.

Network users download upgrades, plug-ins, programs and applications from various sources, such as Internet websites, cable-based service providers, CD ROMs, and the like. Although a number of security mechanisms are available to these service providers, hosts and end users, it remains problematic to ensure that the downloaded module has not been tampered with or otherwise modified from its original form. Similarly, despite presently known security mechanisms, it is difficult for distributors to ensure that only authorized end users receive the distributed modules.

A method is thus needed which facilitates the secure distribution and downloading of software in a network environment, which assures the integrity of the download to the end users and, at the same time, ensures the distributor that only authorized end users receive the distributed software.

### BRIEF DESCRIPTION OF THE DRAWING

The present invention will hereinafter be described in conjunction with the appended drawing FIGURE, which sets forth the salient steps of the method of the present invention in flowchart form.

### DETAILED DESCRIPTION OF THE DRAWING

The present invention provides a method for securely distributing software components in a network environment. In accordance with the present invention, a secure kernel and a configuration file containing a load table are initially loaded onto each network appliance. The secure kernel includes the minimum amount of boot code for allowing the network appliance to initially boot up and establish communication with the network host. The secure kernel also contains a security mechanism, such as an algorithm or other device for verifying the authenticity of the configuration file associated with the network appliance. Inasmuch as the present invention contemplates downloading and perhaps overwriting an entire operating system program, it may be desirable for the secure kernel to be installed in and execute from a non-volatile memory location in the network appliance which is protected from user access.

In a preferred embodiment, the configuration file associated with each network appliance is digitally signed or otherwise encoded by the network host to ensure the authenticity of the load table within the configuration file. For example, prior to loading a configuration file on to a network appliance, the entire file may be hashed and signed by the network host or, alternatively, it may be signed or otherwise encoded for security by an agent of the network host, for example, an authorized software distribution center, broadcaster, service provider, or other content source which resides on or is otherwise associated with the network. In this way, the secure kernel may unambiguously confirm the authenticity of the configuration file and, significantly, of the load table within the configuration file. The load table may set forth the authorized software components, hardware components and, if desired, the source (distributor) of these components, as well as the order in which they should be loaded.

Referring now to the FIGURE, a method 100 for securely distributing software upgrades will now be described. Upon hardware reset, the secure kernel is executed and the boot code executed (step 102). The secure kernel then checks for the presence of a configuration file (step 104). If no configuration file exists, the network appliance sends a request to the host for a configuration file (step 106). Upon receipt of a signed configuration file (step 108) or, alternatively, upon confirmation that a configuration file already exists (“yes” branch from step 104), the secure kernel performs integrity and authentication checks on the configuration file (step 110). For example, the secure kernel may employ an algorithm or other security mechanism to verify the authenticity of a configuration file. If the integrity and/or authentication checks fail (“yes” branch from step 112), the secure kernel logs this failure (step 114) and sends a request to the host for a new configuration file (step 106). In this regard, it is possible that the integrity/authenticity checks on the configuration file may fail because the user has tampered with the configuration file in an attempt to obtain unauthorized access to a program, application, or the like.

If the integrity and/or authenticity checks on the configuration file confirm the authenticity and integrity of the file (“no” branch from step 112), the secure kernel reads the load table from the configuration file and loads and initiates the appropriate software components—e.g., a paid television program (step 116) as defined by the load table. In this regard, if the load table indicates that the programs, modules, plug-ins, updates, or even a new operating system are specified but do not currently exist on the network appliance, the secure kernel will begin loading the components, plug-ins, and the like, and will adhere to any load priorities which may be set forth in the configuration file.

In the event that all of the components specified in the load table cannot be properly loaded and attached to the operating system, the secure kernel generates an error message and, if desired, may prevent execution of code outside of the secure kernel until all specified components can be properly loaded. For this reason, inter alia, it may be desirable for the configuration file to include information as to the source of any components specified in the load table, so that the secure kernel may send a request through the network for any needed components. In a preferred embodiment, this request is sent to the host, whereupon the host would transmit a copy of the needed component to the network appliance. To further ensure integrity and authenticity, the distributor of the component (e.g., the network host) may hash and sign the component before sending it to the network appliance. Once received by the network appliance, the secure kernel can confirm the authenticity of the component.

Component or operating system upgrades that are downloaded during normal operation may be initiated by the software distribution center (e.g., the network host) or may be requested by an end user. If the end user requests a component download (“yes” branch from step 118), the secure kernel returns to step 110 to confirm the integrity and authenticity of the configuration file before downloading the requested component. If, on the other hand, the network host (or other component distributor) desires to download a component to the network appliance, or desires to confirm the current content of the load table for a network appliance, the network host can request access to the configuration file associated with the network appliance (step 120). Upon receipt of a request for the configuration file (“yes” branch from step 120), the secure kernel transmits the configuration file to the requesting source (step 122). If the requesting source simply desires to view the contents of the configuration file, no further action need be taken. If, on the other hand, based on a review of the configuration file the requesting source desires to update the configuration file, the updated configuration file would then be signed by or on behalf of the network host and returned to the network appliance, whereupon the integrity and authenticity of the updated configuration file would be confirmed by the secure kernel.

Although the present invention has been described with reference to the drawing FIGURE, those skilled in the art will appreciate that the scope of the invention is not limited to the specific forms shown in the drawing FIGURE. Various modifications, substitutions, and enhancements may be made to the descriptions set forth herein, without departing from the spirit and scope of the invention which is set forth in the appended claims.

What is claimed is:

1. A method for securely distributing a component from a network host to a network appliance, comprising the steps of:
signing, by said network host, a configuration file including a load table which defines a plurality of authorized components for said network appliance;
executing a secure kernel and said signed configuration file on said network appliance, said secure kernel including computer code for checking the authenticity of said configuration file;
verifying, by said secure kernel, the authenticity of said configuration file;
reading, by said secure kernel, said load table only after said verifying step; and
loading said plurality of authorized components onto said network appliance.

2. The method of claim 1, wherein said loading step comprises loading an operating system.

3. The method of claim 1, wherein said loading step comprises loading a computer software application.

4. The method of claim 1, wherein said loading step comprises loading services.

5. The method of claim 1, further comprising the steps of:
generating, by said host, an updated configuration file;
signing, by said host, said updated configuration file;
transmitting said signed updated configuration file from said host to said network appliance;
verifying, by said secure kernel, the authenticity of said updated configuration file; and
thereafter reading, by said secure kernel, said updated configuration file.
